(19) United States
(12) Patent Application Publication
(10) Pub. No.: US 2026/0145478 A1
(43) Pub. Date: May 28, 2026

(54) VEHICLE HEIGHT CONTROL DEVICE AND VEHICLE HEIGHT CONTROL METHOD

(71) Applicant: TOYOTA JIDOSHA KABUSHIKI KAISHA, Toyota-shi (JP)

(72) Inventors: Kazuyuki MURATA, Toyota-shi (JP); Ryo KANDA, Nissin-shi (JP); Masaaki HASEGAWA, Nagoya-shi (JP); Tomoaki HIRAI, Nissin-shi (JP)

(73) Assignee: TOYOTA JIDOSHA KABUSHIKI KAISHA, Toyota-shi (JP)

(21) Appl. No.: 19/359,977

(22) Filed: Oct. 16, 2025

(30) Foreign Application Priority Data
Nov. 28, 2024 (JP) 2024-207037

(51) Int. Cl. B60G 17/017; B60G 17/019

(52) U.S. Cl. CPC B60G 17/017; B60G 17/019; B60G 2400/208; B60G 2400/252; B60G 2400/34; B60G 2400/52

(57) ABSTRACT

A vehicle height control device includes: an acquisition unit configured to: acquire information regarding vehicle heights at a pair of rear wheels or air pressures of the rear wheels from rear-wheel-side sensors provided for the respective rear wheels; acquire information regarding wheel speeds of a pair of front wheels and the rear wheels; and acquire a detection result of an accelerator operation by a driver; a decision unit configured to determine to raise the vehicle height when all of the following conditions are satisfied: (i) determination is made that a stuck state has occurred, (ii) a rotating wheel and a stopped wheel are included among the front wheels and the rear wheels, and (iii) the accelerator operation by the driver is detected; and a control unit configured to control, according to a determination result from the decision unit, a vehicle height adjustment mechanism provided for the rear wheels.

### CROSS-REFERENCE TO RELATED APPLICATION

This application claims priority to Japanese Patent Application No. 2024-207037 filed on November 28, 2024. The disclosure of the above-identified application, including the specification, drawings, and claims, is incorporated by reference herein in its entirety.

### BACKGROUND

### 1. Technical Field

The present disclosure relates to techniques for adjusting vehicle height by controlling a vehicle height adjustment mechanism.

### 2. Description of Related Art

Japanese Unexamined Patent Application Publication No. 2007-191073 (JP 2007-191073 A) discloses a vehicle height adjustment system that includes four vehicle height change actuators and a vehicle height adjustment control device. The vehicle height change actuators are disposed between a vehicle body and four drive wheels, namely right and left front wheels and right and left rear wheels. Each vehicle height change actuator is configured to change the vehicle height between a corresponding one of the drive wheels and the vehicle body. The vehicle height adjustment control device is configured to control the vehicle height change actuators to adjust the vehicle height. The vehicle height adjustment control device includes a stuck determination unit configured to determine that a stuck condition has occurred when all of the following conditions are satisfied: (i) the vehicle height corresponding to any one of the four drive wheels is greater than or equal to a set value, (ii) the driver has an intention to drive, and (iii) the vehicle is not moving.

### SUMMARY

When the underfloor portion of the vehicle body comes into contact with the road surface and one of the wheels is lifted off the ground, the vehicle may enter a stuck state. However, there is a possibility of recovery by raising the vehicle height such that one of the wheels comes into contact with the ground. In a vehicle provided with a vehicle height adjustment mechanism on the rear wheel side, it is preferable to accurately identify a stuck state from which recovery is possible by raising the vehicle height.

An object of the present disclosure is to provide a technique capable of accurately identifying a stuck state from which recovery is possible by raising the vehicle height.

In order to achieve the above object, a vehicle height control device according to an aspect of the present disclosure includes an acquisition unit, a decision unit, and a control unit. The acquisition unit is configured to: acquire information regarding vehicle heights at a pair of rear wheels or air pressures of the rear wheels from rear-wheel-side sensors provided for the respective rear wheels; acquire information regarding wheel speeds of a pair of front wheels and the rear wheels; and acquire a detection result of an accelerator operation by a driver. The decision unit is configured to determine to raise the vehicle height when all of the following conditions are satisfied: (i) determination is made, based on the vehicle heights at the rear wheels or the air pressures of the rear wheels, that a stuck state has occurred, (ii) a rotating wheel and a stopped wheel are included among the front wheels and the rear wheels, and (iii) the accelerator operation by the driver is detected. The control unit is configured to control, in accordance with a determination result from the decision unit, a vehicle height adjustment mechanism provided for the rear wheels.

Another aspect of the present disclosure is a vehicle height control method that is executed by a computer. This method includes: acquiring vehicle heights at a pair of rear wheels or air pressures of the rear wheels from rear-wheel-side sensors provided for the respective rear wheels, acquiring information regarding wheel speeds of a pair of front wheels and the rear wheels, and acquiring a detection result of an accelerator operation by a driver; determining to raise the vehicle height when all of the following conditions are satisfied: (i) determination is made, based on the vehicle heights at the rear wheels or the air pressures of the rear wheels, that a stuck state has occurred, (ii) a rotating wheel and a stopped wheel are included among the front wheels and the rear wheels, and (iii) the accelerator operation by the driver is detected; and executing, in accordance with a result of the determining, control to raise the vehicle height by controlling a vehicle height adjustment mechanism provided for the rear wheels.

The present disclosure can provide a technique capable of accurately identifying a stuck state from which recovery is possible by raising the vehicle height.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a vehicle height control system according to an embodiment;

FIG. 2 shows a functional configuration of the vehicle height control system; and

FIG. 3 is a flowchart showing a vehicle height control method according to the embodiment.

### DETAILED DESCRIPTION OF EMBODIMENTS

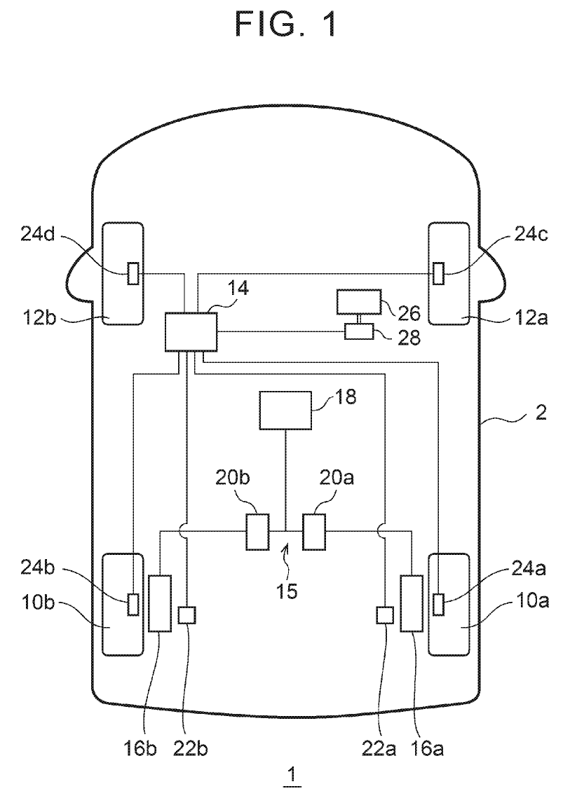

FIG. 1 shows the configuration of a vehicle height control system 1 according to an embodiment. The vehicle height control system 1 is mounted in a vehicle 2, and is configured to adjust the vehicle height on the rear wheel side. The vehicle 2 may have an autonomous driving control function that allows the vehicle 2 to travel autonomously. The vehicle 2 includes a right rear wheel 10a and a left rear wheel 10b (collectively referred to as "rear wheel 10" or "rear wheels 10" when not distinguished), a right front wheel 12a and a left front wheel 12b (collectively referred to as "front wheel 12" or "front wheels 12" when not distinguished), and the vehicle height control system 1.

The vehicle height control system 1 includes a vehicle height control device 14, a vehicle height adjustment mechanism 15, a right vehicle height detection sensor 22a and a left vehicle height detection sensor 22b (collectively referred to as "vehicle height detection sensor 22" or "vehicle height detection sensors 22" when not distinguished), a first wheel speed detection sensor 24a, a second wheel speed detection sensor 24b, a third wheel speed detection sensor 24c, a fourth wheel speed detection sensor 24d, and an accelerator operation detection sensor 28.

The vehicle height adjustment mechanism 15 is configured to adjust the vehicle heights at the rear wheels 10. The vehicle height adjustment mechanism 15 includes a right suspension device 16a and a left suspension device 16b (collectively referred to as "suspension device 16" or "suspension devices 16" when not distinguished), a high-pressure source 18, a right valve 20a, and a left valve 20b. The right suspension device 16a is connected to the right rear wheel 10a and a vehicle body. The left suspension device 16b is connected to the left rear wheel 10b and the vehicle body. The suspension devices 16 are configured as extendable and contractible pneumatic devices. However, the suspension devices 16 are not limited to this, and may be hydraulic devices.

The high-pressure source 18 takes in air and supplies air pressurized by a motor to the suspension device 16. The right valve 20a is provided in a supply path from the high-pressure source 18 to the right suspension device 16a. The left valve 20b is provided in a supply path from the high-pressure source 18 to the left suspension device 16b. The right valve 20a and the left valve 20b are leveling valves with adjustable opening degrees.

When the right valve 20a is opened, pressurized air is supplied from the high-pressure source 18 to the right suspension device 16a, causing the right suspension device 16a to extend and the vehicle height at the right rear wheel 10a to be raised. When the left valve 20b is opened, pressurized air is supplied from the high-pressure source 18 to the left suspension device 16b, causing the left suspension device 16b to extend and the vehicle height at the left rear wheel 10b to be raised. An exhaust valve (not shown) is provided in the supply path between the high-pressure source 18 and each suspension device 16. When the exhaust valve is opened, the suspension device 16 is depressurized and contracts. The opening and closing of the right valve 20a and the left valve 20b are controlled by the vehicle height control device 14.

The right vehicle height detection sensor 22a detects the amount of extension or contraction of the right suspension device 16a, and detects the vehicle height at the right rear wheel 10a based on the detected amount. The left vehicle height detection sensor 22b detects the amount of extension or contraction of the left suspension device 16b, and detects the vehicle height at the left rear wheel 10b based on the detected amount. The vehicle height detection sensors 22 transmits the detection results to the vehicle height control device 14. The vehicle height detection sensors 22 are not limited to a configuration that detects the amount of extension or contraction of the suspension device 16, and may instead be an optical or ultrasonic sensor that detects the distance between the vehicle body and the road surface.

Each of the first wheel speed detection sensor 24a, the second wheel speed detection sensor 24b, the third wheel speed detection sensor 24c, and the fourth wheel speed detection sensor 24d (collectively referred to as "wheel speed detection sensor 24" or "wheel speed detection sensors 24" when not distinguished) detects the wheel speed, namely the rotational speed of a corresponding one of the wheels, and transmits the detection result to the vehicle height control device 14.

An accelerator pedal 26 is operated by the driver. The accelerator operation detection sensor 28 detects an accelerator operation by the driver, and transmits the detection result to the vehicle height control device 14. The accelerator operation detection sensor 28 detects, for example, the amount of displacement of the accelerator pedal 26.

The vehicle height control device 14 controls the vehicle height adjustment mechanism 15 based on the detection results from the vehicle height detection sensors 22, the wheel speed detection sensors 24, and the accelerator operation detection sensor 28, to raise or lower the vehicle heights at the rear wheels 10.

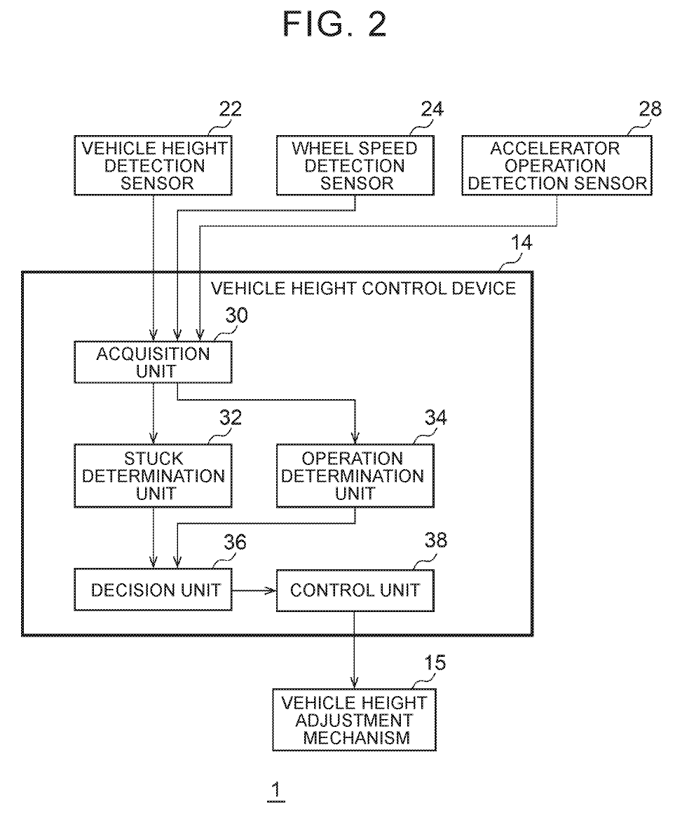

FIG. 2 shows a functional configuration of the vehicle height control system 1. The vehicle height control device 14 includes an acquisition unit 30, a stuck determination unit 32, an operation determination unit 34, a decision unit 36, and a control unit 38. The acquisition unit 30 acquires information regarding the vehicle height at the rear wheels 10 from the vehicle height detection sensors 22. The information regarding the vehicle height at the rear wheel 10 may be a distance from the road surface, or may be a sensor value prior to calculation of the distance from the road surface.

The acquisition unit 30 acquires information regarding the wheel speeds of the rear wheels 10 and the front wheels 12 from the wheel speed detection sensors 24. The information regarding the wheel speed may be a wheel speed, or may be a rotational speed or sensor value prior to calculation of the wheel speed. The acquisition unit 30 acquires a detection result of an accelerator operation by the driver from the accelerator operation detection sensor 28.

The stuck determination unit 32 determines whether the vehicle 2 is in a stuck state based on the vehicle heights at the rear wheels 10, and also determines whether the vehicle 2 is in a stuck state based on each wheel speed. The stuck determination unit 32 determines whether the vehicle heights at the rear wheels 10 are less than or equal to a predetermined height, and whether the difference between the vehicle heights at the rear wheels 10 is greater than or equal to a predetermined difference.

The stuck determination unit 32 determines that one of the wheels of the vehicle 2 is in a stuck state, when the vehicle heights at the rear wheels 10 are less than or equal to the predetermined height, or when the difference between the vehicle heights at the rear wheels 10 is greater than or equal to the predetermined difference. When the vehicle heights at the rear wheels 10 are less than or equal to the predetermined height, it is likely that the vehicle heights at both rear wheels 10 are excessively lowered, and that the front wheel 12 side is lifted. When the difference between the vehicle heights at the rear wheels 10 is greater than or equal to the predetermined difference, it is likely that the vehicle height at one rear wheel 10 is raised, and that the vehicle height at the other rear wheel 10 is lowered. The predetermined height and the predetermined difference are set in advance through experiments etc. As described above, the stuck state of the vehicle 2 can be determined using the sensors for the rear wheels 10. In particular, by determining that the vehicle heights at the rear wheels 10 are less than or equal to the predetermined height, the stuck state on the front wheel 12 side can be identified even without the sensors for the front wheels 12.

The stuck determination unit 32 determines, based on the wheel speed of each wheel, whether a rotating wheel and a stopped wheel are included among the front wheels 12 and the rear wheels 10. The stuck determination unit 32 determines that a wheel is a rotating wheel when its wheel speed is greater than or equal to a predetermined high speed. The stuck determination unit 32 determines that a wheel is a stopped wheel when its wheel speed is less than or equal to a predetermined low speed. The stuck determination unit 32 may determine that a rotating wheel and a stopped wheel are included when the difference between the wheel speeds of the wheels is greater than or equal to a predetermined speed.

When both a rotating wheel and a stopped wheel are included, it is likely that a stuck state has occurred. However, when the wheel speeds alone are used for determination, the vehicle may be stuck in mud or snow, and the situation may not be resolved by vehicle height adjustment. Therefore, by including the vehicle heights at the rear wheels 10 as a determination condition, it is possible to accurately identify a stuck state from which recovery is possible by raising the vehicle height.

The operation determination unit 34 determines, based on the detection result from the accelerator operation detection sensor 28, whether an accelerator operation has been performed by the driver, and whether an accelerator operation amount is greater than or equal to a predetermined amount. The operation determination unit 34 determines that an accelerator operation has been performed when the accelerator operation amount is greater than or equal to the predetermined amount.

The decision unit 36 receives the determination results from the stuck determination unit 32 and the operation determination unit 34, and based on these results, determines whether to raise the vehicle height. The decision unit 36 determines to raise the vehicle height when all of the following conditions are satisfied: (i) it is determined, based on the vehicle heights at the rear wheels 10, that a stuck state has occurred, (ii) a rotating wheel and a stopped wheel are included among the front wheels 12 and the rear wheels 10, and (iii) an accelerator operation by the driver is detected. Accordingly, a stuck state from which recovery is possible by raising the vehicle height can be accurately identified by using the vehicle height detection sensors 22 provided for the rear wheels 10, in combination with the existing wheel speed detection sensors 24 and the existing accelerator operation detection sensor 28.

The decision unit 36 determines to raise the vehicle height when all of the following conditions are satisfied: (i) each of the vehicle heights at the rear wheels is less than or equal to the predetermined height, or the difference between the vehicle heights at the rear wheels is greater than or equal to the predetermined difference, (ii) a rotating wheel and a stopped wheel are included among the front wheels and the rear wheels, and (iii) an accelerator operation by the driver is detected.

The decision unit 36 determines to raise the vehicle height of the rear wheel 10 having a lower vehicle height out of the pair of rear wheels 10. The decision unit 36 determines to raise the vehicle heights at both rear wheels 10 when both of the vehicle heights at the rear wheels 10 are less than or equal to the predetermined height. The decision unit 36 determines to raise the vehicle height at the rear wheel 10 having a lower vehicle height when the difference between the vehicle heights at the rear wheels 10 is greater than or equal to the predetermined difference.

The control unit 38 controls the vehicle height adjustment mechanism 15 provided for the pair of rear wheels 10 in accordance with the determination result from the decision unit 36. The control unit 38 increases the pressure of the high-pressure source 18 to open either or both of the right valve 20a and the left valve 20b, thereby extending the suspension device 16 to raise the vehicle height.

The control unit 38 raises the vehicle height at the rear wheel 10 having a lower vehicle height. When the decision unit 36 determines to raise the vehicle height, the control unit 38 raises the vehicle heights at the rear wheels 10 when each of the vehicle heights at the rear wheels 10 is less than or equal to the predetermined height, and raises the vehicle height at the rear wheel 10 having a lower vehicle height out of the pair of rear wheels 10 when the difference between the vehicle heights at the rear wheels 10 is greater than or equal to the predetermined difference.

In a modification, the vehicle height control device 14 may use detection results from air pressure detection sensors instead of the vehicle height detection sensors 22. That is, rear-wheel-side sensors that detect the degrees of compression at the rear wheels 10 may be the vehicle height detection sensors 22 or air pressure detection sensors. The air pressure detection sensors each detect the air pressure of a corresponding one of the right and left rear wheels 10a, 10b and transmit the detection results to the vehicle height control device 14. The acquisition unit 30 acquires the air pressures of the rear wheels 10 from the air pressure detection sensors.

The stuck determination unit 32 determines that a stuck state has occurred when each of the air pressures of the rear wheels 10 is greater than or equal to a predetermined pressure, or when the difference between the air pressures of the rear wheels 10 is greater than or equal to a predetermined difference. The decision unit 36 determines to raise the vehicle height when all of the following conditions are satisfied: (i) each of the air pressures of the rear wheels 10 is greater than or equal to the predetermined pressure, or the difference between the air pressures of the rear wheels 10 is greater than or equal to the predetermined difference, (ii) a rotating wheel and a stopped wheel are included among the front wheels 12 and the rear wheels 10, and (iii) an accelerator operation by the driver is detected.

When each of the air pressures of the rear wheels 10 is greater than or equal to the predetermined pressure, it is likely that both rear wheels 10 are excessively compressed and that the vehicle 2 is in a stuck state. When the difference between the air pressures of the rear wheels 10 is greater than or equal to the predetermined difference, it is likely that one of the rear wheels 10 is compressed and that the vehicle 2 is in a stuck state.

The stuck determination unit 32 may determine whether a stuck state has occurred using detection results from both the vehicle height detection sensors 22 and the air pressure detection sensors. That is, the decision unit 36 may determine whether to raise the vehicle height, additionally based on whether the air pressures of the rear wheels 10 satisfy a predetermined condition. For example, the decision unit 36 may determine to raise the vehicle height when all of the following conditions are satisfied: (i) it is determined, based on the vehicle heights at the rear wheels 10, that a stuck state has occurred, (ii) it is determined, based on the air pressures of the rear wheels 10, that a stuck state has occurred, (iii) a rotating wheel and a stopped wheel are included among the wheels, and (iv) an accelerator operation by the driver is detected.

In another modification, the acquisition unit 30 acquires the air pressure of each wheel from the air pressure detection sensors provided for the wheels. The stuck determination unit 32 determines that a stuck state has occurred when the air pressure of at least one of the front wheels 12 is less than or equal to a predetermined low pressure and each of the air pressures of the rear wheels 10 is greater than or equal to a predetermined high pressure. In this case, it is likely that at least one of the front wheels 12 is extended while the rear wheels 10 are compressed and that a stuck state has occurred. The stuck state can thus be accurately determined based on the detection results from the air pressure detection sensors.

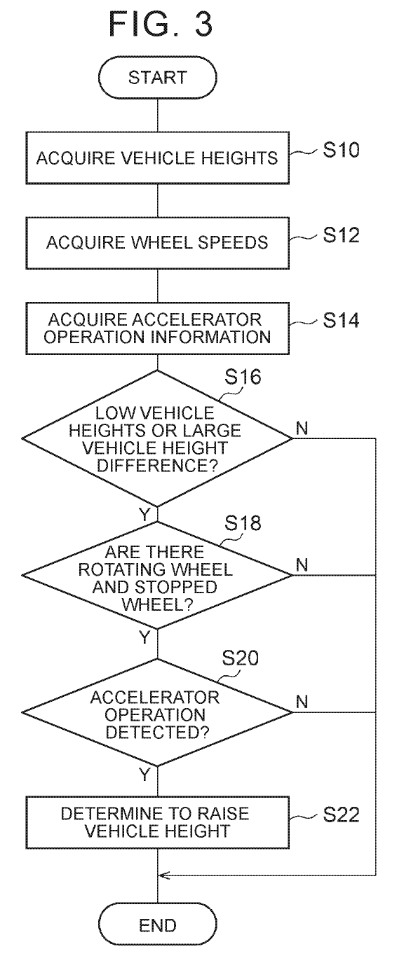

FIG. 3 is a flowchart showing a vehicle height control method according to the embodiment. The acquisition unit 30 acquires information regarding the vehicle heights at the rear wheels 10 from the vehicle height detection sensors 22 (S10), acquires information regarding the wheel speeds of the rear wheels 10 and the front wheels 12 from the wheel speed detection sensors 24 (S12), and acquires a detection result of an accelerator operation by the driver from the accelerator operation detection sensor 28 (S14).

The stuck determination unit 32 determines whether the vehicle heights at the rear wheels 10 are less than or equal to the predetermined height, or whether the difference between the vehicle heights at the rear wheels 10 is greater than or equal to the predetermined difference (S16). When the vehicle heights at the rear wheels 10 are greater than the predetermined height and the difference between the vehicle heights at the rear wheels 10 is less than the predetermined difference (N in S16), the process ends without raising the vehicle height.

When the vehicle heights at the rear wheels 10 are less than or equal to the predetermined height or the difference between the vehicle heights at the rear wheels 10 is greater than or equal to the predetermined difference (Y in S16), the stuck determination unit 32 determines, based on the wheel speed of each wheel, whether a rotating wheel and a stopped wheel are included among the front wheels 12 and the rear wheels 10 (S18).

When neither a rotating wheel nor a stopped wheel is included among the front wheels 12 and the rear wheels 10 (N in S18), the process ends without raising the vehicle height. When a rotating wheel and a stopped wheel are included among the front wheels 12 and the rear wheels 10 (Y in S18), the operation determination unit 34 determines whether an accelerator operation by the driver has been detected (S20).

When no accelerator operation by the driver is detected (N in S20), the process ends without raising the vehicle height. When an accelerator operation by the driver is detected (Y in S20), the decision unit 36 determines to raise the vehicle height (S22). The control unit 38 executes control to raise the vehicle height at the rear wheel 10 having a lower height.

The present disclosure has been described above based on the embodiment. The present disclosure is not limited to the above embodiment, and various modifications including design changes may be made based on the knowledge of those skilled in the art.

What is claimed is:

1. A vehicle height control device comprising:
an acquisition unit configured to: acquire information regarding vehicle heights at a pair of rear wheels or air pressures of the rear wheels from rear-wheel-side sensors provided for the respective rear wheels; acquire information regarding wheel speeds of a pair of front wheels and the rear wheels; and acquire a detection result of an accelerator operation by a driver;
a decision unit configured to determine to raise the vehicle height when all of the following conditions are satisfied: (i) determination is made, based on the vehicle heights at the rear wheels or the air pressures of the rear wheels, that a stuck state has occurred, (ii) a rotating wheel and a stopped wheel are included among the front wheels and the rear wheels, and (iii) the accelerator operation by the driver is detected; and
a control unit configured to control, in accordance with a determination result from the decision unit, a vehicle height adjustment mechanism provided for the rear wheels.

2. The vehicle height control device according to claim 1, wherein:
the rear-wheel-side sensor is a vehicle height detection sensor; and
the decision unit is configured to determine to raise the vehicle height when all of the following conditions are satisfied: (i) each of the vehicle heights at the rear wheels is less than or equal to a predetermined height, or a difference between the vehicle heights at the rear wheels is greater than or equal to a predetermined difference, (ii) the rotating wheel and the stopped wheel are included among the front wheels and the rear wheels, and (iii) the accelerator operation by the driver is detected.

3. The vehicle height control device according to claim 1, wherein:
the rear-wheel-side sensor is an air pressure detection sensor configured to detect the air pressure of the rear wheel; and
the decision unit is configured to determine to raise the vehicle height when all of the following conditions are satisfied: (i) each of the air pressures of the rear wheels is greater than or equal to a predetermined pressure, or a difference between the air pressures of the rear wheels is greater than or equal to a predetermined difference, (ii) the rotating wheel and the stopped wheel are included among the front wheels and the rear wheels, and (iii) the accelerator operation by the driver is detected.

4. The vehicle height control device according to claim 1, wherein when the decision unit determines to raise the vehicle height, the control unit raises the vehicle heights at the rear wheels when each of the vehicle heights at the rear wheels is less than or equal to a predetermined height, and raises the vehicle height at the rear wheel having a lower vehicle height out of the rear wheels when a difference between the vehicle heights at the rear wheels is greater than or equal to a predetermined difference.

5. A vehicle height control method that is executed by a computer, the vehicle height control method comprising:
acquiring vehicle heights at a pair of rear wheels or air pressures of the rear wheels from rear-wheel-side sensors provided for the respective rear wheels, acquiring information regarding wheel speeds of a pair of front wheels and the rear wheels, and acquiring a detection result of an accelerator operation by a driver;
determining to raise the vehicle height when all of the following conditions are satisfied: (i) determination is made, based on the vehicle heights at the rear wheels or the air pressures of the rear wheels, that a stuck state has occurred, (ii) a rotating wheel and a stopped wheel are included among the front wheels and the rear wheels, and (iii) the accelerator operation by the driver is detected; and
executing, in accordance with a result of the determining, control to raise the vehicle height by controlling a vehicle height adjustment mechanism provided for the rear wheels.
